(19) United States
(12) Patent Application Publication
(10) Pub. No.: US 2026/0222828 A1
(43) Pub. Date: Jul. 30, 2026

(54) SYSTEM AND METHOD FOR MITIGATING CONFIGURATION CONFLICTS IN OPEN RADIO ACCESS NETWORK (RAN) APPLICATION PROGRAMS

(71) Applicants: AT&T Intellectual Property I, L.P., Atlanta, GA (US); AT&T Technical Services Company, Inc., Vienna, VA (US)

(72) Inventors: Thomas W. Henderson, Alpharetta, GA (US); David Ross Beppler, Duluth, GA (US); Daniel Vivanco, Ashburn, VA (US)

(73) Assignees: AT&T Intellectual Property I, L.P., Atlanta, GA (US); AT&T Technical Services Company, Inc., Vienna, VA (US)

(21) Appl. No.: 19/037,466

(22) Filed: Jan. 27, 2025

(51) Int. Cl. H04W 24/02; H04L 41/5009; H04W 24/08

(52) U.S. Cl. CPC H04W 24/02; H04L 41/5009; H04W 24/08

(57) ABSTRACT

Aspects of the subject disclosure may include, for example, mitigating configuration conflicts in Open Radio Access Network (ORAN) application programs. The technical problem addressed is the simultaneous modification of configuration management parameters by multiple applications, which can lead to increased signaling load and suboptimal network performance. The solution involves monitoring configuration management parameter changes executed by application programs within a RAN Intelligent Controller (RIC) framework, determining a composite configuration management parameter setting based on performance feedback, and dynamically adjusting this setting in response to network condition changes to maintain performance. This technology can be used in mobile communication systems to enhance network adaptability and efficiency. Components include a processing system that coordinates application program execution to ensure synchronized parameter modifications, thereby reducing conflicts and control signaling load. Other embodiments are disclosed.

### FIELD OF THE DISCLOSURE

The subject disclosure relates to a system and method for mitigating configuration conflicts in Open Radio Access Network (ORAN) application programs.

### BACKGROUND

In the realm of modern telecommunications, the Open Radio Access Network (ORAN) architecture represents a significant shift towards more flexible and interoperable network systems. The ORAN architecture is designed to enhance the efficiency and scalability of radio access networks by promoting openness and standardization. At the core of this architecture is the RAN Intelligent Controller (RIC), which plays a pivotal role in managing and optimizing network functions. The RIC is divided into two main components: the Non-Real-Time RIC and the Near-Real-Time RIC, each responsible for different aspects of network management.

The Non-Real-Time RIC is primarily concerned with long-term network optimization and policy management. The Non-Real-Time RIC hosts application programs, referred to as rApps, which are specialized applications designed to perform tasks such as network analytics, configuration management, and policy enforcement. These applications operate on a timescale that allows for strategic adjustments to network parameters, ensuring that the network can adapt to changing conditions and demands. The rApps analyze network data to make informed decisions that enhance the overall performance and efficiency of the network. By adjusting network parameters based on evolving conditions and demands, the rApps ensure that the network remains adaptable and resilient over extended periods. Their role is crucial in maintaining the balance between network performance and resource utilization, providing a foundation for the dynamic and flexible management of modern telecommunications networks.

Conversely, the Near-Real-Time RIC focuses on short-term, tactical network optimizations. The Near-Real-Time RIC hosts xApps, which are applications that execute more immediate control functions, such as load balancing and interference management. These applications are designed to perform short-term, tactical network optimizations, focusing on immediate control functions such as load balancing and interference management. Operating on a rapid timescale, xApps respond swiftly to real-time network events and conditions, enabling the network to adapt quickly to changes and maintain optimal performance. By executing precise adjustments to network parameters, xApps play a vital role in ensuring the network's responsiveness and efficiency. Their ability to provide immediate solutions to dynamic challenges complements the long-term strategies managed by rApps, together forming a comprehensive approach to network management that balances strategic planning with real-time adaptability.

The integration of rApps and xApps within the RIC framework enables a comprehensive approach to network management, where both long-term strategies and immediate actions are coordinated to optimize network performance.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a network system in accordance with various aspects described herein.

FIG. 2A is a block diagram illustrating an example, non-limiting embodiment of an ORAN system functioning within the network system of FIG. 1 in accordance with various aspects described herein.

FIG. 2B is a block diagram illustrating an example, non-limiting embodiment of an ORAN instance cycle functioning within the ORAN system of FIG. 2A in accordance with various aspects described herein.

FIG. 2C is a block diagram illustrating an example, non-limiting embodiment of an example mapping of configuration management parameters to RIC application programs functioning within the network system of FIG. 1 in accordance with various aspects described herein.

FIG. 2D is a block diagram illustrating another example, non-limiting embodiment of an ORAN system functioning within the network system of FIG. 1 in accordance with various aspects described herein.

FIG. 2E is a graph illustrating an example, non-limiting embodiment of a timing diagram of rApp and xApp instances of an ORAN system functioning within the network system of FIG. 1 in accordance with various aspects described herein.

FIG. 2F is a block diagram illustrating an example, non-limiting embodiment of an arrangement of macro cells operating according to an ORAN architecture and functioning within the network system of FIG. 1 in accordance with various aspects described herein.

FIG. 2G is a graph illustrating an example, non-limiting embodiment of a timing diagram of rApp instances operating according to the arrangement of macro cells of FIG. 2F in accordance with various aspects described herein.

FIG. 2H is a block diagram illustrating an example, non-limiting embodiment of another arrangement of macro cells operating according to an ORAN architecture and functioning within the network system of FIG. 1 in accordance with various aspects described herein.

FIG. 2I is a graph illustrating an example, non-limiting embodiment of a timing diagram of rApp instances operating according to the arrangement of macro cells of FIG. 2H in accordance with various aspects described herein.

FIG. 2J depicts an illustrative embodiment of a process for mitigating configuration conflicts among ORAN application programs in accordance with various aspects described herein.

FIG. 2K depicts another illustrative embodiment of a process for mitigating configuration conflicts among ORAN application programs in accordance with various aspects described herein.

FIG. 3 is a block diagram illustrating an example, non-limiting embodiment of a virtualized network system in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for mitigating configuration conflicts in ORAN systems by determining composite configuration management parameters and dynamically managing changes to these parameters across rApps and xApps to enhance network performance and reduce signaling load. Other embodiments are described in the subject disclosure.

One or more aspects of the subject disclosure include a process comprising monitoring configuration management parameter changes executed by a group of application programs operating within a radio access network (RAN) intelligent controller (RIC) framework of a mobile communication system, wherein the configuration management parameter changes adapt the mobile communication system according to mobile service requirements. A composite configuration management parameter setting is determined based on performance measurements feedback. The composite configuration management parameter setting is applied across the group of application programs. Network condition changes of the mobile communication system are monitored and the composite configuration management parameter setting is dynamically adjusted responsive to the network condition changes to maintain network performance.

In at least some embodiments of the process, the disclosure includes a process wherein the composite configuration management parameter setting includes a weighted aggregate of individual configuration management parameter changes. The application programs include one of a near-real-time, xApp application program, a non-real-time, rApp application program, or a combination thereof.

In at least some embodiments of the process, the process further includes determining network conditions, wherein the composite configuration management parameter setting is based on network conditions.

In at least some embodiments of the process, the determining the composite configuration management parameter setting further includes optimizing one or more composite configuration management parameters of the composite configuration management parameter setting to obtain an optimized composite configuration management parameter setting.

In at least some embodiments of the process, the process further includes identifying conflicts occurring within the configuration management parameter changes, wherein the composite configuration management parameter setting is configured to reduce the conflicts.

In at least some embodiments of the process, the composite configuration management parameter setting is configured to reduce a control signaling load within the RAN. In at least some embodiments, the process further includes coordinating execution of the application programs to ensure synchronized modifications of configuration management parameters, thereby mitigating oscillating of the configuration management parameter changes.

In at least some embodiments of the process, the process further includes identifying a group of neighboring cells, and monitoring performance measurement feedback for the group of neighboring cells, wherein the performance measurement feedback is responsive to the configuration management parameter changes.

In at least some embodiments of the process, the process further includes detecting a performance degradation based on the performance measurement feedback and determining an association between the performance degradation and the configuration management parameter changes.

In at least some embodiments of the process, the process further includes obtaining performance measurement feedback and determining the composite configuration management parameter setting based on performance measurements feedback.

In at least some embodiments of the process, the network condition changes include one of busy hours, emergencies and combinations thereof.

One or more aspects of the subject disclosure include a device including a processing system including a processor and a memory that stores executable instructions. The instructions, when executed by the processing system, facilitate performance of operations. The operations include observing configuration management parameter changes executed by a group of application programs operating within a radio access network (RAN) intelligent controller (RIC), wherein the configuration management parameter changes adapt a mobile communication system according to mobile service requirements. A compromise configuration management parameter setting is determined based on performance measurements feedback. The compromise configuration management parameter setting is applied across the group of application programs. Network condition changes of the mobile communication system are monitored and the compromise configuration management parameter setting is dynamically adjusted responsive to the network condition changes to maintain network performance.

In at least some embodiments of the device the application programs include one of a near-real-time, xApp application program, a non-real-time, rApp application program, or a combination thereof.

In at least some embodiments of the device, the compromise configuration management parameter setting includes a weighted aggregate of individual configuration management parameter changes.

In at least some embodiments of the device, the operations further include coordinating execution of the application programs to ensure synchronized modifications of configuration management parameters, thereby mitigating oscillating of the configuration management parameter changes.

In at least some embodiments of the device, the operations further include identifying a group of neighboring cells, and monitoring performance measurement feedback for the group of neighboring cells, wherein the performance measurement feedback is responsive to the configuration management parameter changes.

In at least some embodiments of the device, a performance degradation is detected based on the performance measurement feedback, and an association is determined between the performance degradation and the configuration management parameter changes.

In at least some embodiments of the device, the operations further include obtaining performance measurement feedback, and determining the compromise configuration management parameter setting based on performance measurements feedback.

In at least some embodiments of the device, the group of neighboring cells comprise at least one of an eNB, a 5G gNB, or a 6G cells.

One or more aspects of the subject disclosure further include a non-transitory machine-readable medium including executable instructions. The instructions, when executed by a processing system including a processor, facilitate performance of operations. The operations include monitoring configuration management parameter changes executed by a group of application programs operating within a radio access network (RAN) intelligent controller (RIC). The configuration management parameter changes adapt a communication system according to performance indicators of a communication system. A compromise configuration management parameter setting is determined based on measurement of the performance indicators. The compromise configuration management parameter setting is applied across the group of application programs. Network condition changes of the communication system are detected and the compromise configuration management parameter setting is dynamically adjusted responsive to the network condition changes to satisfy the performance indicators.

In at least some embodiments of the non-transitory machine-readable medium, the operations further include coordinating execution of the application programs to ensure synchronized modifications of configuration management parameters, thereby mitigating oscillation of the configuration management parameter changes. These and other features will be more clearly understood from the following detailed description taken in conjunction with the accompanying drawings and claims.

The integration of rApps and xApps within the RIC framework enables a comprehensive approach to network management, where both long-term strategies and immediate actions are coordinated to optimize network performance. However, this dynamic environment also introduces challenges, particularly when multiple applications attempt to modify the same Configuration Management (CM) parameters simultaneously. Such conflicts can lead to increased signaling load and suboptimal network performance, necessitating advanced solutions to manage these interactions effectively. The techniques disclosed herein address these challenges, e.g., by monitoring the usage of configuration management parameters by the different rApps and/or xApps, identifying potential conflicts and in at least some instances, identifying and/or implementing strategies to mitigate such potential conflicts.

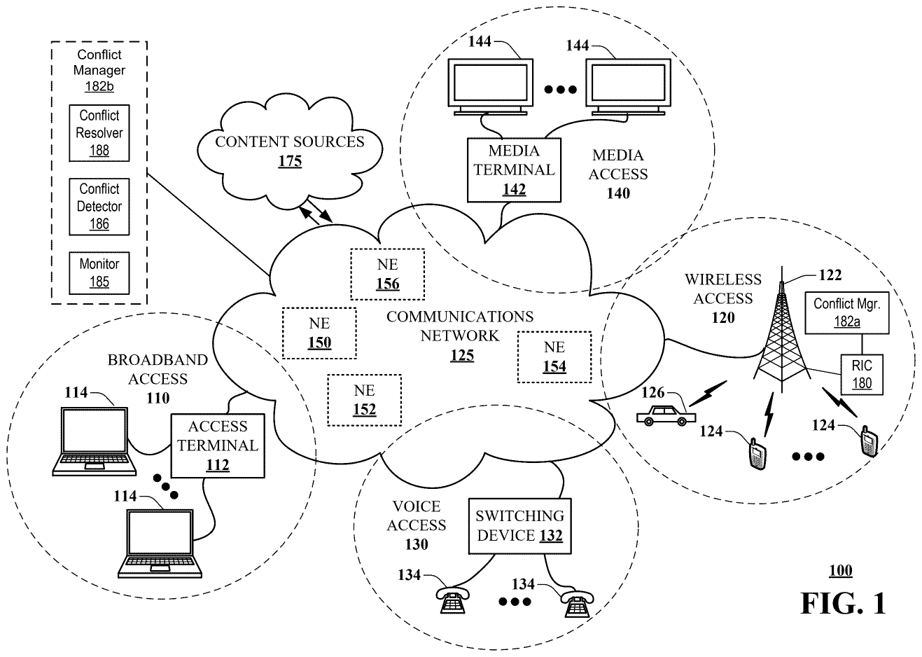

Referring now to FIG. 1, a block diagram is shown illustrating an example, non-limiting embodiment of a network system 100 in accordance with various aspects described herein. For example, the network system 100 can facilitate in whole or in part monitoring configuration management parameter changes over a group of application programs, e.g., xApps and/or rApps, in a RIC and mitigating configuration conflicts in ORAN systems by determining composite configuration management parameters that can be dynamically managed changed across the application programs to enhance network performance and reduce signaling load. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc., for facilitating the broadband access 110, wireless access 120, voice access 130, media access 140 and/or the distribution of content from content sources 175. The communications network 125 can include a circuit switched or packet switched network, a voice over Internet protocol (VOIP) network, voice over new radio (VoNR), Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc., can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

In at least some embodiments, the network system 100 includes an ORAN architecture, e.g., supporting operations of the wireless access network. For example, equipment supporting the wireless access 120 can include a RIC 180 in communication with the base station or access point 122. The RIC 180 can be configured to manage radio access network operations by coordinating the execution of rApps and xApps, thereby enhancing network performance and adaptability through real-time and strategic adjustments to configuration management parameters. The equipment supporting the wireless access 120 can further include one or more conflict managers 182a, 182b, generally 182, in communication with the RIC 180. The conflict manager 182 can be configured to monitor configuration management parameter changes over a group of application programs, e.g., xApps and/or rApps, in the RIC 180 and mitigate configuration conflicts related to the ORAN architecture.

In at least some embodiments, the configuration conflicts can be managed by determining composite configuration management parameters that can be dynamically managed changed across the application programs to enhance network performance and reduce signaling load. In more detail, the conflict manager 182 can include a monitoring module 185, e.g., configured to monitor ORAN activity including configuration parameters and/or performance measurements, e.g., KPIs, of the wireless access 120, including the base station or access point 122, transport networks and/or mobility core networks. In at least some embodiment, the conflict manager 182 can include a conflict detector module 186 and a conflict resolution module 188. The conflict detector module 186 may be configured to detect conflicts, e.g., based on monitored activity obtained via the monitor module 185. The conflict resolver module 188, can be adapted to identify, propose and/or otherwise facilitate resolution to any conflicts responsive to conflicts being detected, predicted, estimated and/or otherwise identified by the conflict detector module 186.

It is envisioned that, in at least some embodiments, one or more of the conflict manager 182, the monitor module 185, the conflict detector module 186 and/or the conflict resolver module 188 may be located in whole or in part proximate to RAN equipment, e.g., near the RIC 180 and/or incorporated into the RIC 180. Alternatively, or in addition, one or more of the conflict manager 182, the monitor module 185, the conflict detector module 186 and/or the conflict resolver module 188 may be located apart from the RIC 180, possibly being remote, e.g., in communication with the RIC 180 via the communications network 125.

Although xApps operate in near-real time, it is understood that conflict monitoring, detection and/or resolution may be conducted according to a different schedule, which may not be in near-real time. That said, any identified conflict resolutions may be implemented into the RAN architecture, e.g., into the RIC 180 and/or the rApps and/or xApps of the RIC 180 to support future and/or continued near-real time operations. For example, monitored activity may be obtained from the RIC 180, stored and processed at a later time and/or at a remote location separate from equipment of the wireless access 120. Conflicts determined in such historical data may be implemented in the RAN architecture, e.g., within the RIC 180 to support continued operations.

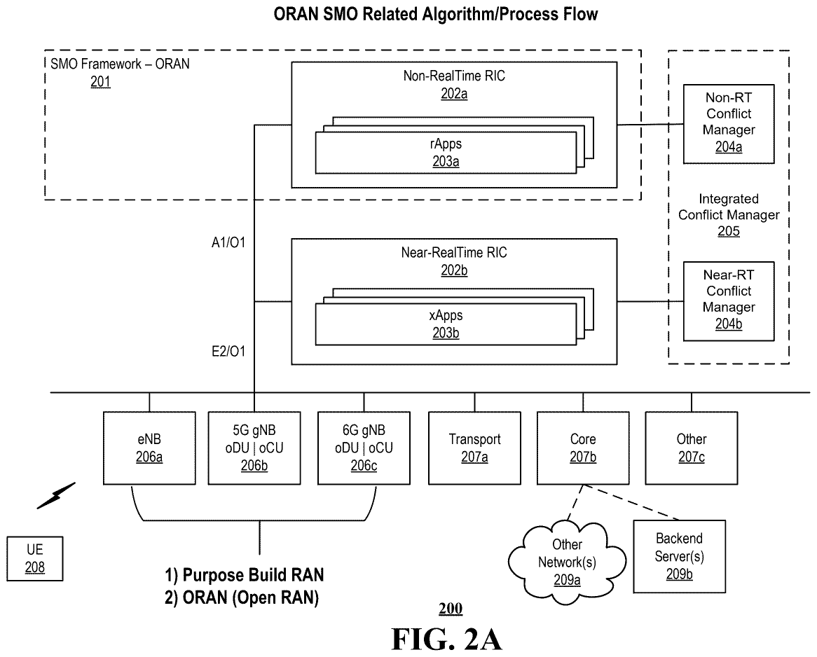

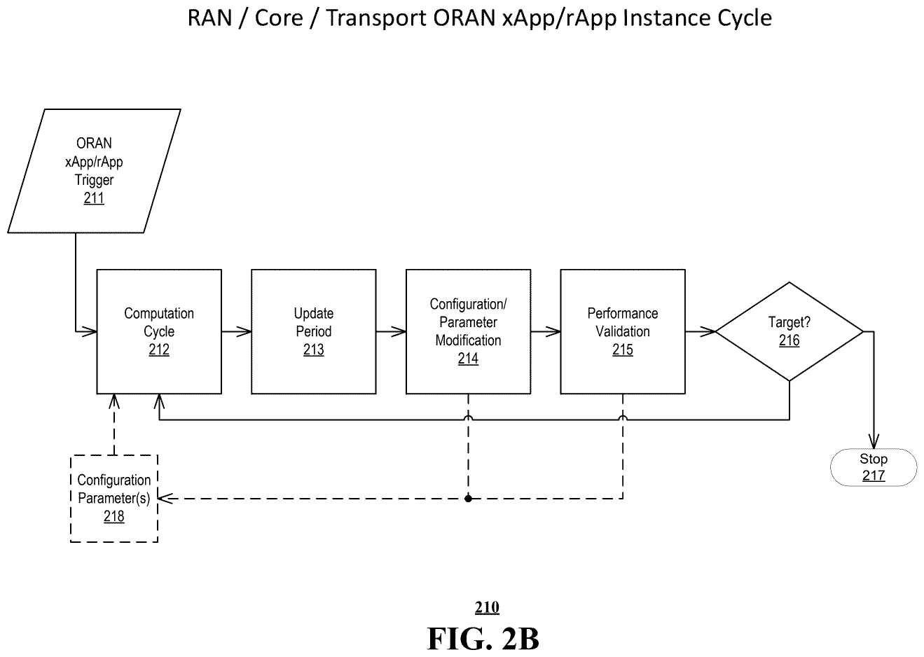

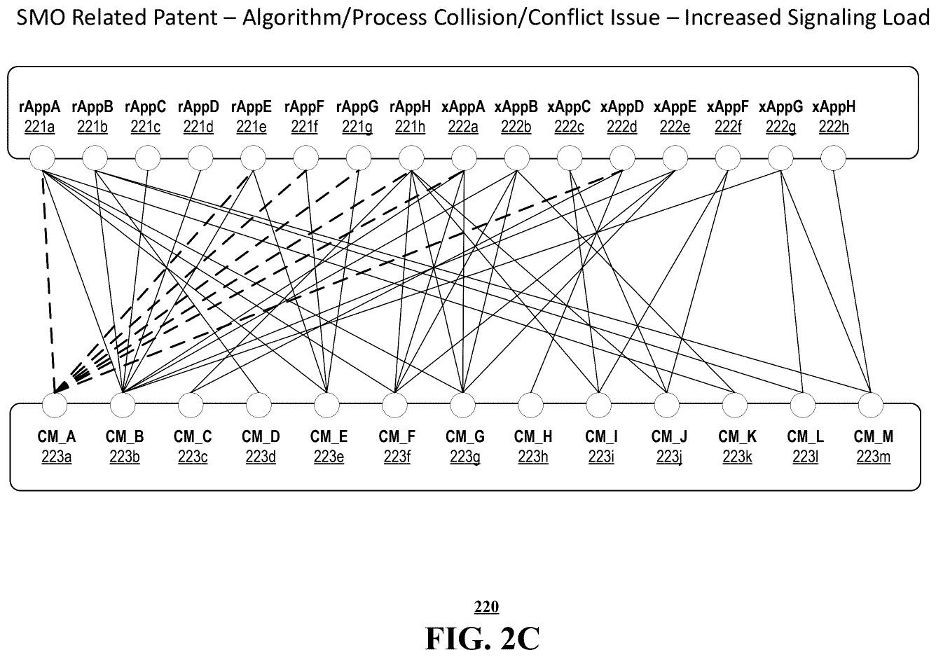

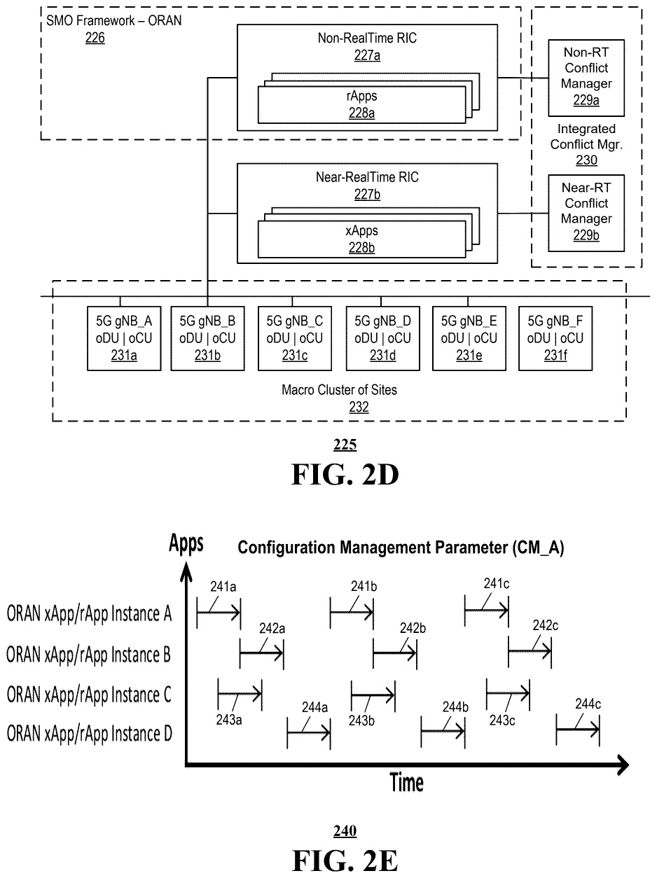

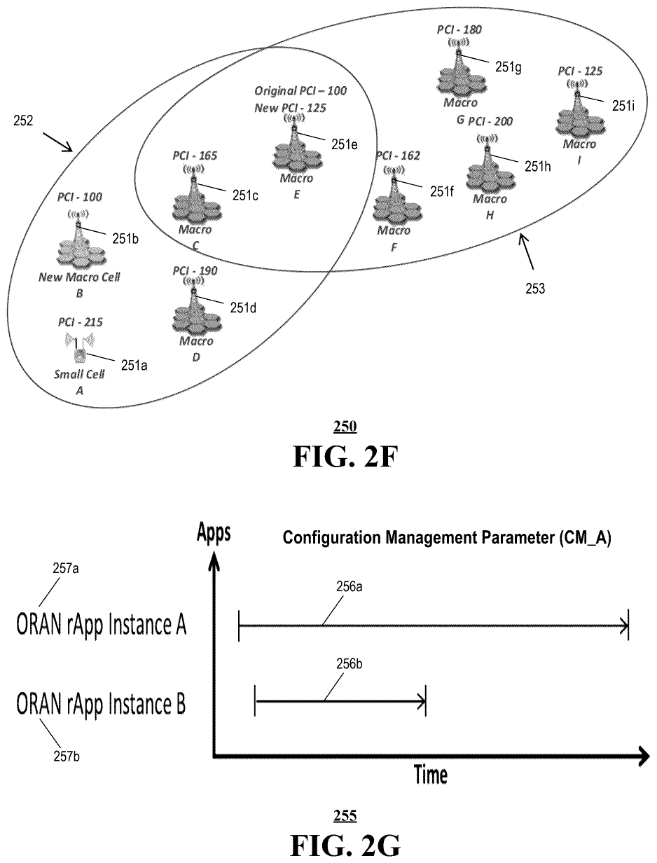

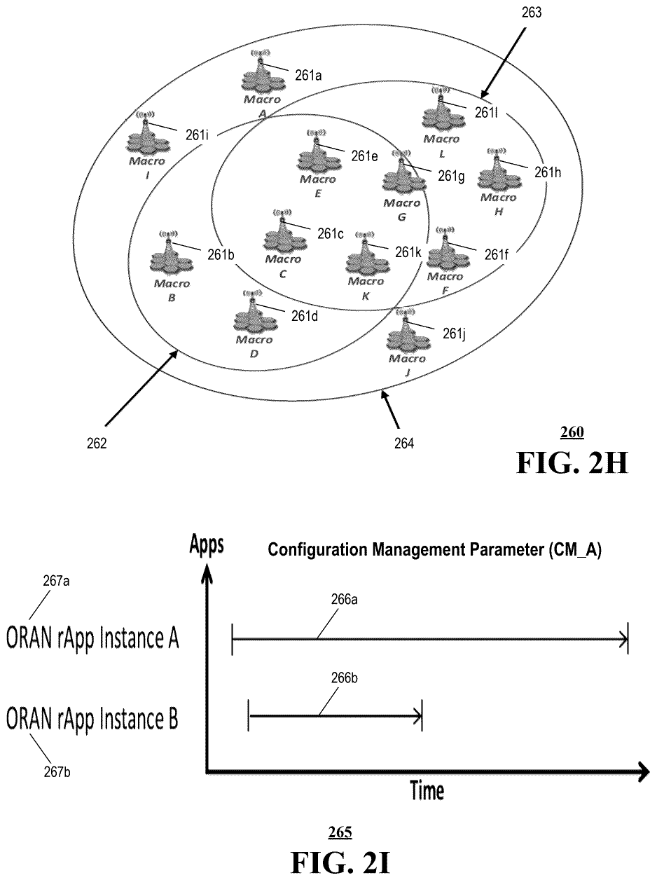

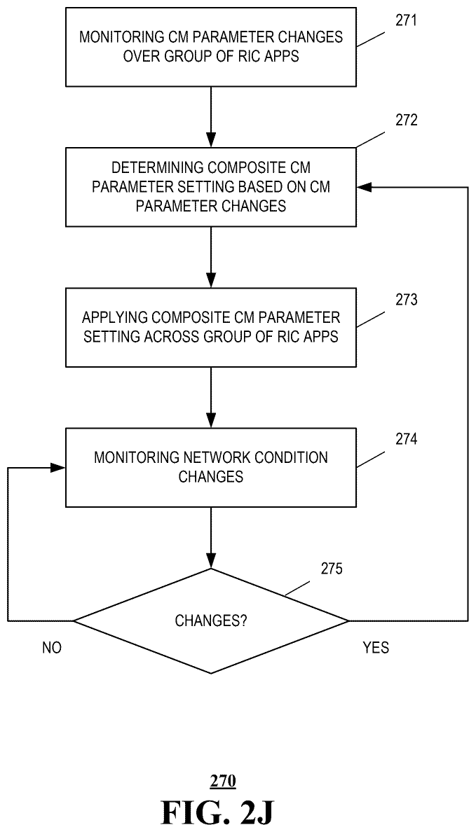

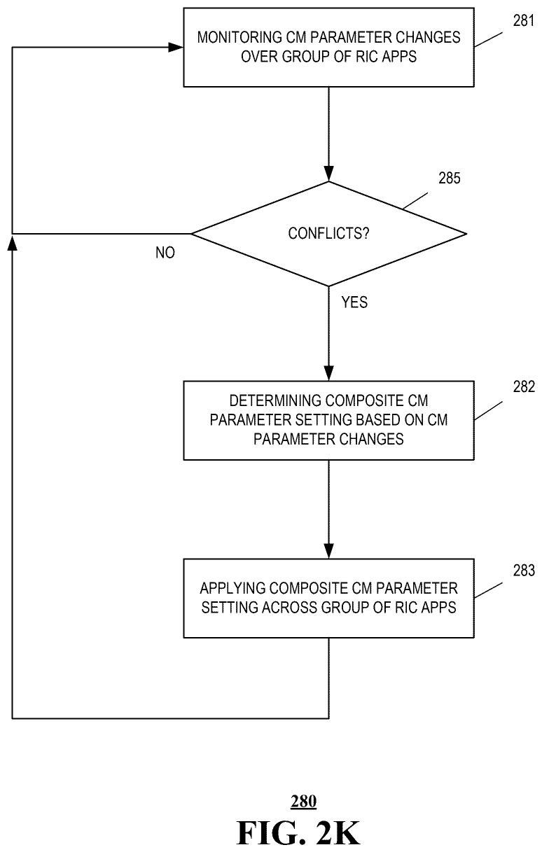

FIG. 2A is a block diagram illustrating an example, non-limiting embodiment of an ORAN system 200 functioning within the network system 100 of FIG. 1 in accordance with various aspects described herein. The ORAN system 200 includes several key components designed to enhance the efficiency and scalability of radio access networks. Central to this system is the service management and orchestration (SMO) platform, or framework 201, which integrates the non-real-time RIC 202a and the near-real-time RIC 202b. The SMO framework 201 serves as the central architecture for managing and optimizing network functions within an ORAN system 200. The SMO framework 201 integrates various components to facilitate efficient and scalable network operations. At its core, the SMO framework 201 includes the non-real-time RIC 202a and the near-real-time RIC 202b. The non-real-time RIC 202a hosts a first group of application programs, e.g., rApps 203a, which are responsible for long-term network optimization and policy management. The near-real-time RIC 202b hosts a second group of application programs, e.g., xApps 203b, which focus on short-term, tactical network optimizations. These applications are responsible for executing long-term strategic and short-term tactical network optimizations.

In at least some embodiments, the ORAN system 200 includes a first non-real-time conflict manager 204a tasked with resolving conflicts between rApps 203a of the non-real time RIC 202a. Alternatively, or in addition, the ORAN system 200 includes a second non-real-time conflict manager 204b tasked with resolving conflicts between xApps 203b of the near-real-time RIC 202b. In at least some embodiments, the ORAN system 200 includes an integrated conflicts manager 205 tasked with resolving conflicts between rApps 203a and xApps 203b. In at least some embodiments, the integrated conflicts manager 205 includes the non-real-time conflict manager 204a and the near-real-time conflict manager 204b and is tasked with resolving conflicts between multiple instances of rApps 203a, multiple instances of xApps 203b, and/or combinations of rApps 203a and xApps 203b. In this regard, the integrated conflict manager 205 provides a unified approach to conflict resolution.

The ORAN system 200 also includes various network elements, such as wireless communication nodes or terminals, e.g., base stations. Without restriction these wireless communication nodes can include an Evolved Node B (eNB) 206a, a 5th generation (5G) Next Generation Node B (gNB) 206b and/or a 6th generation (6G) gNB 206c, or beyond and the ORAN equivalent O-DU, O-CU and O-RU. In at least some embodiments, the ORAN system 200 includes one or more other network elements, such as the example transport network 207a, core network 207b, and/or still other components 207c that can operate to enhance functionality and performance.

The transport network 207a can include a front-haul transport network, e.g., between geographically distributed open radio units (O-RUs) to open distributed digital units (O-DUs). For example, the front haul transport network can provide network connectivity between centralized open or purpose built baseband units (BBUs) and open and purpose built remote radio heads (RRHs) at the access layer of the network. Alternatively, or in addition, the transport network can include a physical infrastructure that connects a local network, device and/or system, to a core network. For example, the transport network 207a can include one or more of a front haul network and a back haul network providing network connectivity between the wireless communication nodes 206a, 206b, 206c, generally 206 and the core network 207b.

In at least some embodiments, the core network 207b refers to a central part of a network infrastructure that is responsible for routing voice, data, and video traffic across large networks, essentially acting as a “backbone” that connects different parts of a network and ensures efficient communication between devices by managing data flow and providing essential services like authentication and subscriber management, e.g., related to data transfer between various network nodes, servers and/or other networks. In a mobility network, the core network 207b refers to a central part of a mobile network. In this instance, the core network 207b manages and controls the services provided to users, including authentication, data routing, billing, and mobility management, essentially acting as the control center for connecting mobile devices to other networks and delivering services like voice calls, SMS, and internet access, ensuring seamless connectivity between users and external networks. It is understood that core networks 207b may be configured to operate according to one or more communication protocols, such as those generally referred to as 4G Long Term Evolution (LTE), 5G, 6G and beyond.

In the context of cellular networks, the base stations, e.g., the example eNB 206a, 5G gNB 206b, and/or 6G gNB 206c represent critical components that facilitate wireless communication between user equipment 208 and a mobility core network. The user equipment 208 can include, without limitation, wireless smart phones, tablets, computers, wearable devices, e.g., smart watches, network-enable devices, such as smart homes, security systems, and more generally, any wireless-enabled device including those configured for machine-type communications, e.g., according to the Internet of Things (IoT). Other examples of user equipment include, without limitation, autonomous vehicles, e.g., self-driving cars, drones, robots, industrial automation and the like. In at least some embodiments, user equipment may be in further communication with other networks 209a and/or servers, e.g., backend servers 209b. Base stations 206 are responsible for managing radio resources, handling data transmission, and maintaining connectivity with mobile devices, e.g., the user equipment 208, within their coverage areas.

In at least some embodiments, the SMO framework 201 coordinates activities of both the non-real-time RIC 202a and the near-real-time RIC 202b, ensuring that long-term strategies and immediate actions are harmonized.

The operability of the ORAN system 200 can be defined by a coordinated interaction of its components. The SMO Framework 201 ensures that both rApps and xApps operate efficiently, with the conflict managers 204a, 204b, and 205 resolving any potential conflicts. For example, the rApps 203a can be configured to perform strategic adjustments to network parameters that are less time critical, while the xApps 203b can be configured to perform more immediate adjustments to network parameters or control functions, allowing the ORAN system 200 to adapt quickly to real-time events. The network elements and transport infrastructure can work together to provide robust connectivity and communication across the network. This modular and adaptable design allows the ORAN system 200 to remain at the forefront of technological advancements in telecommunications, ensuring optimal network performance and resource utilization.

FIG. 2B is a block diagram illustrating an example, non-limiting embodiment of an ORAN instance cycler 210 functioning within the ORAN system of FIG. 2A in accordance with various aspects described herein. The ORAN instance cycler 210, includes several key components that facilitate the execution and optimization of xApp and rApp processes within an ORAN system, e.g., according to the SMO framework 201 (FIG. 2A). The example ORAN instance cycler 210 includes a trigger module 211. The trigger module 211 can be configured to monitor one or more items according to a rule, a policy and/or a threshold. The items may include, without limitation, network conditions, events, alarms, and/or parameters, e.g., key performance indicators (KPI). Observation results, which may include numeric values, alarm conditions, parameter values, may be interpreted by the trigger module 211, e.g., to determine whether a trigger should be asserted and/or otherwise initiated. In at least some embodiments, interpretation may include comparison of one or more monitored items to predetermined values, ranges and/or thresholds. In at least some embodiments, the interpretation may include pre-processing of the monitored items, e.g., performing combinations of one or more items and/or implementing logical operations, e.g., AND, OR, NOT, XOR, and so on, according to the monitored items.

In network applications, KPIs can include metrics useful in evaluating one or more of a performance, an efficiency, and/or a quality of a network. These indicators can provide insights into various aspects of a network's operation and help network operators ensure optimal service delivery. By way of example, some common KPIs in mobile communication systems include, without limitation, throughput, latency, call setup success rate (CSSR), call drop rate (CDR), packet loss rate, handover success rate, signal quality, e.g., signal-to-interference-plus-noise ratio (SINR) and/or reference signal receive quality (RSRQ), network availability, user equipment battery life, customer satisfaction index (CSI). These KPIs can support network operation by their monitoring and/or adjustment to facilitate establishment, maintenance, improvement and/or optimization of performance of mobile communication systems, thereby ensuring high-quality service delivery to users.

The example ORAN instance cycler 210 includes a computation cycle module 212 in communication with the trigger module 211. Following assertion of a trigger, the computation cycle module 212 can be configured to execute one or more computation and/or evaluation processes, algorithms and/or calculations. In this manner and in at least some embodiments, the computation cycle module 212 can determine appropriate actions that bay be required and/or at least advisable based on assertion of the trigger. In at least some embodiments, the computation cycle module 212 can initiate one or more processes. It is understood that in at least some embodiments, the processes can alter, adjust, set and/or reset one or more configuration parameters 218.

In an ORAN system, configuration management parameters can be used to define and/or otherwise control a network's operational settings. According to the illustrative example, the computation cycle module 212 may receive one or more configuration parameters 218, e.g., from one or more of the rApps 203a and/or xApps 203b, and/or from one or more of the RICs 202a, 202b, and/or from other elements of the ORAN system 200. The configuration management parameters can ensure that the network functions satisfactorily, and even optimally. Moreover, configurability of the configuration management parameters facilitates adaptation of the network, e.g., to respond to varying conditions and/or requirements. By way of example, configuration management parameters in an ORAN system can include one or more of physical cell identities (PCIs), transmission power levels, antenna orientation, e.g., tilt and/or azimuth, frequency band and/or channel allocations, handover thresholds, quality of service (QoS) profiles, load balancing, neighbor cell list(s), security settings and/or network slicing configurations. In at least some embodiments, one or more of a number of available configuration management parameters can be managed by one or more of the rApps 203a and/or one or more of the xApps 203b (FIG. 2A) within the ORAN architecture, allowing the network to remain adaptable, efficient, and capable of meeting the demands of users and applications.

In operation, one or more computation cycles initiated by the computation cycle module 212, e.g., the processes initiated and/or otherwise associated with the one or more computation cycles, can operate according to one or more schedules. The example ORAN instance cycler 210 includes an update period module 213. It is understood that in at least some embodiments, the update period module 213 may configure and/or otherwise impose one or more update cycles, e.g., according to the one or more schedules. For example, the update period module 213 dan define an interval according to which a system, e.g., the ORAN System 200 (FIG. 2A), checks for new data and/or conditions that may require adjustments. In some embodiments, the triggered process(es) are performed once. Alternatively, or in addition, the schedules can identify update cycles that may be performed on a periodic basis, e.g., according to respective process cycle periods and/or frequencies. For example, a first process, once triggered, may be repeated according to a first update period T_{Update_1}. Similarly, a second process, once triggered by the same trigger, or perhaps some other trigger, may be repeated according to a second update period T_{Update_2}. The first and second update period may be the same or different. Alternatively, or in addition, the first and second update periods may operate according to a relative offset time T_{offset}, e.g., determined according to a difference in trigger times.

In at least some embodiments, the ORAN instance cycler 210 includes a configuration parameter modification module 214. The configuration parameter modification module 214 can be in communication with the update period module 213 and configured to perform any changes to the network parameters and/or configuration management parameters, as may be necessary. For example, the configuration parameter modification module may be configured to compute one or more network parameters and/or configuration management parameters responsive to the computation cycle as may be modified according to the update period module 213. Without limitation, this may include generation of and/or modification of one or more configuration parameter values.

It is worth noting here, that, in at least some embodiments, the ORAN instance cycler 210 may be implemented in one or more of the non-real-time RIC 202a or the near-real-time RIC 202b (FIG. 2A). Accordingly, one or more of the triggers identified by the trigger module 211, the computation cycles imitated by the computation cycle module 212, the update periods determined by the update period module 213 and the configuration parameter modifications computed, calculated and/or otherwise determined by the configuration parameter modification module may relate to one or more of the rApps 203a or the xApps 203b (FIG. 2A). Namely, the ORAN instance cycler 210 may operate at least some cycles that are associated with one or more of the rApps 203a or the xApps 203b. To the extent multiple cycles are initiated, it is envisioned that the at least some of the cycles may operate in a simultaneous, contemporaneous and/or overlapping manner. In some instances, at least some of the cycles may operate independently, while in other instances, at least some of the cycles may be interrelated, e.g., operating upon the same configuration parameters and/or according to the same update periods, and/or subjected to the same configuration parameter modifications.

In at least some embodiments, the ORAN instance cycler 210 includes a performance validation module 215. The performance validation module 215 can be configured to assess an effectiveness of modifications proposed, suggested, recommended and/or otherwise implemented, e.g., by the configuration parameter modification module 214. For example, the performance validation module 215 may evaluate modified configuration parameters before they are implemented in the ORAN system 200. Evaluations may include calculations, predictions, estimations, e.g., according to one or more models of the ORAN system 200 and/or subsystems or elements of the ORAN system 200, such as the rApps 203a and/or the xApps 203b. Alternatively, and/or in addition the evaluations may include comparisons of the modified configuration parameters to prior results and/or observations under the same and/or similar configuration parameters to anticipate results and/or consequences of their implementation in the ORAN system 200 based on any observed prior results and/or consequences. In at least some embodiments, the performance validation module 215 performs an evaluation, including, for example, any of the aforementioned techniques, after the configuration management parameters have been modified and applied within the ORAN system 200. According to these example techniques, the performance validation module 215 can be configured to ensure that desired outcomes are achieved.

The example ORAN instance cycler 210 also includes a target evaluation module 216 in communication with the performance validation module 215 and the computation cycle module 212. The target evaluation module 216 can be configured to determine whether a target goal has been satisfied as a result of the computation cycle. To the extent that the target evaluation module 216 indicates that the target goal has been satisfied, the computation cycle may be concluded at a pause, termination or stop 217. However, to the extent that the target evaluation module 216 indicates that the target goal has not been satisfied, the computation cycle may be repeat, e.g., according to the update period. It is envisioned that in at least some embodiments, the configuration parameter modifications implemented by the configuration parameter modification module 214 may depend upon prior modifications, e.g., operating in an iterative manner to achieve the target goal, which in at least some embodiments may be based on network parameters, which may include one or more KPIs. According to the illustrative example, one or more configuration parameters 218 may be introduced, updated and/or otherwise modified by one or more of the configuration parameter modification module 214 and/or the performance validation module 215.

The computation cycle 212 can feed into the update period 213, to ensure that the system 200 and/or the ORAN instance cycler 210 remains responsive to new data and conditions. Interconnection of the update period 213 to the configuration/parameter modification module 214, allows for timely adjustments to network parameters. According to the illustrative example, the performance validation module 215 is directly linked to the configuration/parameter modification module 214, providing feedback on the effectiveness of the changes. The decision point, e.g., the target module 216, evaluates the results of the performance validation module 215, e.g., to determine whether the cycle should continue or stop.

The operability of the ORAN instance cycler 210 is integral to the overall functionality of the ORAN system 200. By coordinating the activities of xApps and rApps, operation of the ORAN instance cycler 210 ensures that network enhancements and/or optimizations are executed efficiently and effectively. An ability of the ORAN instance cycler 210 to dynamically adjust network parameters in response to real-time conditions enhances the adaptability and performance of the ORAN system 200. The integration of the ORAN instance cycler 210 with the broader ORAN framework, including the SMO framework 201, RIC components 202a, 202b, and conflict managers, ensures that both long-term strategies and immediate actions are harmonized, optimizing network performance and resource utilization.

It is understood that collisions and/or conflicts can occur between competing rApps 203a, xApps 203b (FIG. 2A). For example, multiple rApps 203a, xApps 203b and/or combinations of rApps 203a and xApps 203b can modify the same and/or similar configuration management parameters 218 (FIG. 2B). The affected configuration management parameters 218 may impact one or more of the 4G nodes 206a, the 5G nodes 206b and/or 6G ORAN nodes 206c, transport components of a transport network 207a, and/or core components of the core network 207b, and/or other components 207c (FIG. 2A). The impact is that competing rApps 203a and/or xApps 203b may trigger and/or modify the same and/or similar configuration management parameters. In at least some scenarios, the same and/or similar configuration management parameters may be modified at different time intervals and/or according to different update cycles or schedules. It is envisioned that such competition for updating the same and/or similar configuration management parameters may result in increases to configuration management parameter iteration changes. This situation will likely also result in an increased signaling load to network resources, e.g., related to the additional iterations.

FIG. 2C is a block diagram illustrating an example, non-limiting embodiment of an example mapping 220 of configuration management parameters to RIC application programs functioning within the network system 100 of FIG. 1 in accordance with various aspects described herein. According to the illustrative example, the non-real-time RIC 202a includes rAppA 221a through rAppH 221h, generally 221. Likewise, the near-real-time RIC 202b includes xAppA 222a through xAppH 222h, generally 222. Various ones of the example rAppAs 221 and the xAppAs 222 may utilize and/or otherwise configure, reconfigure or adjust one or more of a group of configuration management parameters, including configuration management parameter CM_A 223a through configuration management parameter CM_M 223m, generally 223.

According to the illustrative example, a first configuration management parameter CM_A 223a may be utilized and/or otherwise configured, reconfigured or adjusted by rAppA 221a, rAppE 221e, rAppF 221f, rAppG 221g, rAppH 221h, as well as xAppA 222a and xAppD 222d. It is conceivable that one of the competing rApps 221 and/or xApps 222 may make an adjustment of the first configuration management parameter CM_A 223a according to a first iteration cycle, while another one of the competing rApps 221 and/or xApps 222 may make an adjustment of the first configuration management parameter CM_A 223a according to a second iteration cycle. In this regard, it is possible that a change implemented by one of the Apps 221, 222 and intended to remain in place for a duration interval, e.g., until a subsequent update and/or iteration, might be modified or essentially undone by one or more of the competing Apps 221, 222. This undoing may require a change back to the original configuration management parameter that would have otherwise been unnecessary. Thus, the ORAN system 200 (FIG. 2A) may lose the benefit of the first example configuration management parameter change as soon as it is undone, while also requiring additional signaling load to revert to the original configuration management parameter value. It is understood that similar situations may be experienced by one or more of the other configuration management parameters 223 further exacerbating the problem.

FIG. 2D is a block diagram illustrating another example, non-limiting embodiment of an ORAN system 225 functioning within the network system 100 of FIG. 1 in accordance with various aspects described herein. The ORAN system 225 includes an SMO platform, or framework 226, which integrates the non-real-time RIC 227a and the near-real-time RIC 227b. The SMO framework 226 includes the non-real-time RIC 227a hosting a first group of application programs, e.g., rApps 228a responsible for long-term network optimization and policy management, while the near-real-time RIC 227b hosts a second group of application programs, e.g., xApps 228b focusing on short-term, tactical network optimizations. The example ORAN system 225 includes a first non-real-time conflict manager 229a, a second non-real-time conflict manager 229b, and in at least some embodiments, an integrated conflicts manager 230.

The ORAN system 225 further multiple macro-cell base stations corresponding to 5G gNB_A 231a through 5G gNB_F 231f, generally 231. At least some of the 5G gNBs 231 are neighbors and can be referred to as a macro cluster 232 of wireless terminals or base stations. In at least some embodiments, the ORAN system 225 may include one or more other network elements (not shown), such as a transport network element, a core network element, and/or still other elements. The SMO framework 226 of the ORAN system 225 can operate to enhance functionality and performance of one or more of the 5G gNBs 231 individually and or collectively, e.g., as the macro cluster 232 or sites.

FIG. 2E is a graph illustrating an example, non-limiting embodiment of a timing diagram 240 of rApp and xApp instances of an ORAN system functioning within the network system of FIG. 1, in accordance with various aspects described herein. The timing diagram 240 relates to a scenario in which four ORAN application program instances, e.g., rApps 228a and/or xApps 228b, generally ORAN rApp/xApp instances 228, modify the same or similar parameter of a network element, e.g., configuration management parameter A (CM_A). According to the illustrative example, the network element is a macro cell base station, e.g., macro 5G gNB_A 231a (FIG. 2D). As illustrated in the timing diagram 240, each ORAN rApp/xApp instance 228 competes against the other ORAN rApp/xApp instances 228 for management of the example CM_A parameter.

It is envisioned that a performance measurement and/or counter, e.g., a KPI target value may differ from one ORAN application program 228 to another. Consequently, the different ORAN rApp/xApp instances 228 may change the CM_A parameter in such a way so as to adversely affect operation of the other ORAN rApp/xApp instances 228. For example, a first ORAN rApp/xApp instance 228 may change the CM_A parameter to a first target value, only to be changed to a second target value by a second ORAN rApp/xApp instance 228. At a next iteration, the first ORAN rApp/xApp instance detects that the CM_A parameter has been changed from the first targe value and invokes a subsequent change to revert the CM_A parameter back to the first target value. The second ORAN rApp/xApp instance 228 may once again, subsequently change the CM_A parameter to the second target value, and so on, e.g., resulting in an inefficient ping-pong adjustment of the configuration management parameter A between the first and second target values. Similar situations may arise between any of the example ORAN r/App/xApp instances 228, depending on differences in target values and/or update periods.

According to the illustrative embodiment, a first ORAN rApp/xApp instance A observes and updates the example CM_A parameter to the first target value as may be necessary during a first time interval 241a. The first ORAN rApp/xApp instance A operates again during second and third time intervals 241b, 241c according to a first update period, observing and changing, e.g., reverting the CM_A parameter back to the first target value as may be necessary at each time interval 241a, 241b, 241c. Likewise, a second ORAN rApp/xApp instance B observes and updates the example CM_A parameter to the second target value as may be necessary during a first time interval 242a and again, as may be necessary, during second and third time intervals 242b, 242c according to a second update period, thereby observing and changing, e.g., reverting the CM_A parameter back to the second target value as may be necessary at each time interval 242a, 242b, 242c.

Continuing with the illustrative example, a third ORAN rApp/xApp instance C observes and updates the example CM_A parameter to a third target value as may be necessary during a first time interval 243a and again, as may be necessary, during second and third time intervals 243b, 243c according to a third update period, thereby observing and changing, e.g., reverting the CM_A parameter back to the third target value as may be necessary at each time interval 243a, 243b, 243c. Similarly, a fourth ORAN rApp/xApp instance D observes and updates the example CM_A parameter to a fourth target value as may be necessary during a first time interval 244a and again, as may be necessary, during second and third time intervals 244b, 244c according to a fourth update period, thereby observing and changing, e.g., reverting the CM_A parameter back to the fourth target value as may be necessary at each time interval 243a, 243b, 243c.

As can be observed in the example timing diagram 240, at least some of the time intervals during which the CM_A parameter is observed and/or updated by each of the ORAN rApp/xApp instances 228 overlap and/or operate according to different update periods that may result pose problems for the intended operation, efficiency and/or optimization goals as may be related to one or more of the ORAN rApp/xApp instances 228. According to the illustrative example, the ORAN rApp/xApp instances 228 are competing against each other at least in relation to the example CM_A parameter, thereby making the individual ORAN rApp/xApp instances 228 operate in a less-than-optical manner.

In reference to Table 1, below, the first ORAN rApp/xApp instance A operates according to a first CM_A parameter target value of “9.” Likewise, the second ORAN rApp/xApp instance B operates according to a second CM_A parameter target value of “6,” the third ORAN rApp/xApp instance C operates according to a third CM_A parameter target value of “8” and the fourth ORAN rApp/xApp instance D operates according to a fourth CM_A parameter target value of “5.” Accordingly, the target values of the CM_A parameter range from 5-9.

TABLE 1
Composite Configuration Parameters.

| | | | Composite |
|---|---|---|---|
| | CM_A | Composite | CM |
| | Parameter | CM | (Busy Hour) |
| ORAN rApp/xApp Instance A | 9 | 7 | 8 |
| ORAN rApp/xApp Instance B | 6 | 7 | 8 |
| ORAN rApp/xApp Instance C | 8 | 7 | 8 |
| ORAN rApp/xApp Instance D | 5 | 7 | 8 |

According to the illustrative techniques disclosed herein changes to the CM_A parameter target values associated with the different ORAN rApp/xApp instances 228 can be observed during an observation period. In at least some embodiments, the target values of one or more of the different ORAN rApp/xApp instances 228 can be adjusted to one or more different values so as to reduce inefficiencies that would otherwise result from the original CM_A parameter target values. For example, observation and/or investigation regarding operation of the different ORAN rApp/xApp instances 228 may result in a determination that one or more of the CM_A parameter target values may be extended to target value ranges. In such instances, adjusted target values may be selected in overlapping portions of the ranges, to the extent there exists an overlap.

For example, ORAN rApp/xApp instance A may operate effectively, if not optimally, over a range of 6-9. Likewise, ORAN rApp/xApp instance B may operate effectively, if not optimally, over a range of 5-8, ORAN rApp/xApp instance C may operate effectively, if not optimally, over a range of 7-8, and ORAN rApp/xApp instance D may operate effectively, if not optimally, over a range of 5-8. It is apparent from the illustrative ranges that there exists an overlap for all four ORAN rApp/xApp instances 228 over a range of 7-8. Further observation, investigation, analysis and/or computation may determine that although all four ORAN rApp/xApp instances 228 may operate effectively over the overlapping range of 7-8, one portion of the range may be better suited to one network condition, whereas, another portion of the range may be better suited to another network condition. Considering the network condition as network utilization, e.g., traffic, number of calls, megabytes downloaded, a first condition may relate to normal network utilization for which a CM_A parameter common target value of 7 may be preferred. Alternatively, a CM_A parameter common target value of 8 may be better suited for greater network utilization, e.g., referred to as busy hour.

In at least some embodiments, the conflict manager(s) 229a, 229b, 230 (FIG. 2D) may be configured to perform determination of compromise target values, e.g., including one or more of observation, investigation, analysis and/or computation as may be related to determining compromise target values for one or more of the CM parameters. Determination of the compromise target values may include identification of performance measures, e.g., KPIs associated with the different ORAN rApp/xApp instances 228 and/or CM parameters. Alternatively, or in addition, determination of the compromise target values observations may include identification of CM parameter target values and/or target value ranges. For example, some CM target values may be observed as they vary over operation of at least one of the ORAN rApp/xApp instances 228.

Determination of the compromise target value may further include identification of variability of performance measures, e.g., KPIs, according to changes in the CM parameter target values. For example, some CM parameters may be more sensitive to variability of target values than others. Alternatively, or in addition, observation may include determination of composite CM parameter target value. The composite CM parameter target value may be determined according to a calculation involving one or more of the observed target values and/or ranges of target values. For example, one or more of the observed target values may be adjusted, e.g., CM parameter target value changes may be averaged and/or weighted. Such averaging and/or weighting may be applied to match ORAN rApp/xApp instances across like CM parameters.

In at least some embodiments, determinations are made as to network conditions, e.g., network traffic conditions, utilization, capacity and so on. Numeric ranges may be determined. Alternatively, or in addition, the conditions may be differentiated according to two or more different conditions, e.g., heavy capacity vs. light capacity. Still other observations may include identification of execution times, execution cycles or periods, and/or triggers across the ORAN rApp/xApp instances.

In at least some embodiments, the composite CM parameter target value and/or target value ranges can be established based on the RAN environment. The RAN environment may include types of RAN equipment, e.g., types, numbers of and/or locations of macro cells, RAN protocols, RAN configurations, e.g., equipment locations, power levels, antenna orientations, and so on, RAN operating conditions, e.g., capacity, utilization, congestion, delays, power levels, bandwidth, modulations, error performance and so on.

In at least some embodiments, the observations and/or determinations are mode at least in part according to CM parameter triggers. It is understood that one or more CM parameter triggers may be modified and/or otherwise aligned across the more than one of the competing ORAN rApp/xApp instances.

In at least some embodiments, the determinations include establishing a composite CM parameter for application across more than one of the competing ORAN rApp/xApp instances. In at least some embodiments, the composite CM parameter can be based at least in part on a condition of the RAN environment.

In at least some embodiments, the determinations include modifying like CM parameter triggers across more than one of the ORAN rApp/xApp instances. For example, trigger modifications can be configured to adjust a trigger threshold, a trigger delay, and so on. Alternatively, or in addition, the determinations can include aligning one or more of the CM parameter triggers across more than one of the ORAN rApp/xApp instances. Trigger alignment may be absolute, e.g., with different triggers based on the same trigger criteria, e.g., the same trigger value, trigger threshold, trigger delay, trigger event and so on. Alternatively, or in addition, a trigger alignment may be relative, e.g., with different triggers based on relative trigger criteria.

In at least some embodiments, modifying and/or alignment of the like CM parameter triggers across more than one of the ORAN rApp/xApp instances can be performed when a CM parameter setting is assigned, reassigned and/or otherwise revised or updated. Alternatively, or in addition, CM parameters may be modified when a composite CM parameter setting is assigned.

In at least some embodiments, observation and/or monitoring of the RAN environment may be based on parameter measurement feedback, e.g., KPI feedback. Alternatively, or in addition, adjustment of the composite CM parameter may be based on parameter feedback, e.g., KPI feedback.

In at least some embodiments, the determination may be performed according to an automated method, process and/or procedure. For example, any combination of any of the foregoing embodiments, including those embodiments related to observation, monitoring and/or adjustment of CM parameter triggers, observation, monitoring and/or adjustment of CM parameters, including composite CM parameters and/or alignment of CM parameter triggers, may be performed automatically and/or dynamically. For example, a related process may be implanted to run automatically. Such automatic processes can be configured to estimate, determine and/or otherwise predict preferable outcomes, e.g., best possible and/or optimal outcomes, based on a composite CM configuration. Preferable outcomes may be determined according to one or more of system performance, e.g., according to performance measurements or KPIs, control signaling loads, and combinations thereof. In at least some embodiments, one or more of the observation of the RAN performance, including performance of the ORAN rApps and/or xApps, monitoring of the RAN performance, including performance of the ORAN rApps and/or xApps, and/or determination of the compromise target values may utilize machine learning (ML) and/or artificial intelligence (AI). Such ML/AI embodiments may include generative AI in which a model, e.g., a deep neural network, may be trained according to training data and applied to operational data to implement one or more of the disclosed operations.

In at least some embodiments, it is envisioned that a restriction, e.g., a lock may be applied to one or more CM parameters and/or CM parameter target values. To the extent such restrictions and/or locks are applied, any composite CM parameters may be determined in view of the restrictions and/or locks. It is envisioned that such restrictions may further limit the availability of viable composite CM parameters. It is envisioned further that such restrictions and/or locks may result in achieving a most efficient, most effective and/or optimal composite CM parameter across competing ORAN rApp/xApp instances. It is envisioned that one or more of the foregoing techniques can be effective in mitigating, e.g., reducing and/or eliminating any possibility of a ping-pong effect in which a CM parameter target value is repeated and unintentionally switched between two or more values.

FIG. 2F is a block diagram illustrating an example, non-limiting embodiment of an arrangement of macro cells 250 operating according to an ORAN architecture and functioning within the network system 100 of FIG. 1 in accordance with various aspects described herein. The arrangement of macro cells 250 comprises a network of macro and small cells designed to provide comprehensive mobile communication coverage and capacity over an extended area. The example arrangement of macro cells 250 includes small cell_A 251a, macro cell_B 251b, macro cell_C 251c, macro cell_D 251d, macro cell E 251_E, macro cell_F 251f, macro cell_G 251g, macro cell_H 251h, and macro cell_I 251i. Each cell 251a through 251i, generally 251, is assigned a unique physical cell identity (PCI) to differentiate it from neighboring cells and manage handovers effectively. The arrangement also features rApp instance_A 257a operating within a first region 252 and rApp instance_B 257b operating within a second region 253, which are responsible for managing and enhancing, e.g., optimizing the network's performance through strategic and tactical adjustments. It is noteworthy that at least a portion of the first region 252 overlaps at least a portion of the second region 253, suggesting a possibility of a spatial conflict.

The interconnections between these components are crucial for ensuring seamless communication and efficient resource utilization. The macro and small cells 251 are strategically positioned to provide overlapping coverage areas, allowing for smooth handovers and minimizing coverage gaps. The rApp instances 257a and 257b are integrated into the network to monitor and adjust the configuration management parameters of the cells, ensuring optimal performance. These rApp instances 257a, 257b, generally 257, communicate with each other and the cells to coordinate their actions and prevent conflicts, such as PCI collisions, which can lead to network inefficiencies and dropped connections.

The example rApp instance_A 257a includes neighboring cells within a first corresponding area or region. These cells include small cell_A 251a, macro cell_B 251b, macro cell_C 251c, macro cell_D 251d, macro cell E 251_E. Likewise, the example rApp instance_B 257b includes neighboring cells within a second corresponding area or region. These cells include macro cell_C 251c, macro cell E 251_E, macro cell_F 251f, macro cell_G 251g, macro cell_H 251h, and macro cell_I 251i. At least some of the cells, e.g., macro cell_C 251c and macro cell E 251_E are members of both rApp instance_A 257a and rApp instance_B 257b.

The operability of the arrangement of macro cells 250 is enhanced by its integration with the broader ORAN system 200. The non-real-time conflict manager 204a, the near-real-time conflict manager and/or the integrated conflict manager 205 of the SMO framework 201 (FIG. 2A) of the ORAN system 200 can be configured to coordinate activities of the rApp instances, ensuring that long-term strategies, the immediate actions and/or combinations of long-term and immediate actions are harmonized. The conflict managers 204a, 204b, 205 within the ORAN system 200 work to resolve any potential conflicts between the rApp instances, maintaining the integrity and performance of the network. By dynamically adjusting network parameters in response to real-time conditions, the arrangement of macro cells 250 ensures robust connectivity, efficient resource utilization, and optimal network performance, aligning with the goals of the ORAN architecture.

The example configuration including rApp instance_A 257a and rApp instance_B 257b presents opportunities for spatial interference and/or spatial collisions across the two different rApp instances 257a, 257b. For example, a PCI value of 100 may be allocated to a new macro cell_B 251b based on neighbor cell configuration in the impact region, e.g., an overlapping between the first and second regions. According to the illustrative example, macro cell_E 251e was originally configured with PCI 100, which presented a conflict in rApp instance_A 257a, to which macro cell_B 251b was assigned the value of PCI 100.

FIG. 2G is a graph illustrating an example, non-limiting embodiment of a timing diagram 255 of rApp instance A 257a and rApp instance B 257b (FIG. 2F) operating according to the arrangement of macro cells 250 of FIG. 2F in accordance with various aspects described herein. According to the illustrative example, the rApp instance A 257a operates over a first time duration 256a, while the rApp instance B 257b operates over a second time interval 256b. It is noteworthy that first and second time intervals 256sa, 256b overlap, indicating a possibility of a timing related conflict Further according to the illustrative example, rApp instance A 257a makes a CM parameter change in macro cell_E 251e, e.g., changing its original PCI of 100 to a new PCE of 125 in order to accommodate incorporation of new macro cell_B 251b into the rApp instance A 257a. However, changing to the new PCI of 125 for macro cell_E 251e impacts a neighbor of a neighbor. Namely, the change impacts macro cell_I 251i, which was configured with a PCI of 125 within rApp instance B 257b. Macro cell_E 251e falls within an impact region of rApp instance A 257a and rApp instance B 257b. Consequently, a change to macro cell_E 251e to accommodate rApp instance A 257a introduces unintended consequences in rApp instance B 257b.

FIG. 2H is a block diagram illustrating an example, non-limiting embodiment of another arrangement of macro cells 260 operating according to an ORAN architecture and functioning within the network system 100 of FIG. 1 in accordance with various aspects described herein. The arrangement of macro cells 260 is designed to provide extensive coverage and capacity in a mobile communication system. This arrangement comprises macro cell_A 261a, macro cell_B 261b, macro cell_C 261c, macro cell_D 261d, macro cell_E 261e, macro cell_F 261f, macro cell_G 261g, macro cell_H 261h, macro cell_I 261i, macro cell_J 261j, macro cell_K 261k, and macro cell_L 2611, generally macro cell 261. Each macro cell 261 can be strategically positioned to ensure optimal coverage and connectivity. The arrangement also features a first impact region 262 associated with ORAN rApp instance A and a second impact region 263 associated with ORAN rApp instance B, which are responsible for managing and optimizing the network's performance through strategic and tactical adjustments. Additionally, a greater area impact region 264 encompasses the collective influence of the first and second impact regions 262, 263 on the network.

The interconnections between these components are crucial for ensuring seamless communication and efficient resource utilization. The macro cells 261 are strategically positioned to provide overlapping coverage areas, allowing for smooth handovers and minimizing coverage gaps. The rApp instances, represented by impact regions 262 and 263, are integrated into the network to monitor and adjust the configuration management parameters of the macro cells, ensuring optimal performance. These rApp instances communicate with each other and the macro cells to coordinate their actions and prevent conflicts, such as PCI collisions, which can lead to network inefficiencies and dropped connections.

The operability of the arrangement of macro cells 260 is enhanced by its integration with the broader ORAN system 200 (FIG. 2A). For example, the SMO framework 201 within the ORAN System 200 coordinates the activities of the rApp instances, ensuring that both long-term strategies and immediate actions are harmonized. The conflict managers within the ORAN System 200 work to resolve any potential conflicts between the rApp instances, maintaining the integrity and performance of the network. By dynamically adjusting network parameters in response to real-time conditions, the arrangement of macro cells 260 ensures robust connectivity, efficient resource utilization, and optimal network performance, aligning with the goals of the ORAN.

In at least some embodiments, logic may be applied to one or more of monitoring of performance parameters, triggers, alarms and/or changes to CM parameters based on the larger or greater area impact region 264, in this instance, encompassing impact regions 262 and 263. Mitigation of perceived and/or actual conflicts can be mitigated by setting an exact value, e.g., a PCI value, and/or establishing a compromise or composite CM parameter as may be advantageous in mitigating any conflict. In at least some embodiments, time periods for determination of instantaneous conditions and/or parameters, e.g., based on alarm triggers, may be averaged. It is further envisioned that in at least some embodiments, additional logic may be applied to manage CM parameters in relation to RAN operations, such as handover neighbor lists. The handover lists can be used to establish impact regions 262, 263, 264 as may be related to conflict evaluations. In at least some embodiments, the impact regions may be based on neighboring cells, neighbors of neighbors, including determination of greater impact regions, and so on as may be relevant to a particular situation.

FIG. 2I is a graph illustrating an example, non-limiting embodiment of a timing diagram of rApp instances operating according to the arrangement of macro cells of FIG. 2H in accordance with various aspects described herein. According to the illustrative example, the rApp instance A 267a operates over a first time duration 266a, while the rApp instance B 267b operates over a second time interval 266b. It is noteworthy that first and second time intervals 266sa, 266b overlap, indicating a possibility of a timing related conflict. Further according to the illustrative example, rApp instance A 267a makes a CM parameter change in macro cell_C 261c, e.g., changing its cell edge power parameters, mobility CM parameters, antenna tilt or orientation. However, changing the CM parameter in relation to macro cell_C 261c impacts a neighboring cell, possibly creating a performance issue, e.g., based on a like CM parameter setting. Namely, the change in macro cell_C 261c impacts macro cell_G 261g, which was configured according to rApp instance B 267b. Macro cell_G 261g falls within an impact region of rApp instance A 267a and rApp instance B 267b. Consequently, a change can be made to macro cell_C 261c and/or macro cell_G 261g to accommodate rApp instance A 267a introduces unintended consequences in rApp instance B 267b. For example, the change(s) may include identification and/or implementation of a compromise CM parameter, e.g., a composite CM parameter, which is suitable for operations of macro cell_C 261c and macro cell_G 261g.

FIG. 2J depicts an illustrative embodiment of a process 270 for mitigating configuration conflicts among ORAN application programs in accordance with various aspects described herein. In at least some embodiments, the process 270 can be implemented by a processing system within a RIC framework to enhance network performance and reduce signaling load. At step 271, the process 270 involves monitoring configuration management (CM) parameter changes executed by a group of RIC application programs, such as rApps and xApps. This step ensures that any modifications to CM parameters are tracked across the application programs.

At step 272, the process 270 determines a composite CM parameter setting based on the observed CM parameter changes. This composite setting can be derived from the individual changes made by the application programs, aiming to optimize the overall network configuration.

At step 273, the composite CM parameter setting can be applied across the group of RIC application programs. This application ensures that all programs operate under a unified configuration, reducing potential conflicts and enhancing network efficiency.

At step 274, the process 270 involves monitoring network condition changes. This step is important for identifying any variations in network performance or requirements that may necessitate adjustments to the CM parameter settings.

At step 275, the process 270 evaluates whether changes in network conditions require adjustments to the composite CM parameter setting. If changes are necessary, the process loops back to step 272 to determine a new composite setting. If no changes are needed, the process continues to monitor the network conditions.

FIG. 2K depicts another illustrative embodiment of a process 280 for mitigating configuration conflicts among ORAN application programs in accordance with various aspects described herein. The example process 280 is configured to manage configuration management (CM) parameter changes within a group of RIC applications, such as rApps and xApps, in an ORAN system. The process 280 is designed to enhance and/or otherwise optimize network performance by addressing potential conflicts in CM parameter settings.

The process begins at step 281, where CM parameter changes are monitored across the group of RIC applications. This monitoring is essential for understanding how different applications impact the network and for identifying any potential conflicts in parameter settings.

At decision point 285, the process evaluates whether any conflicts exist among the CM parameter changes. To the extent it is determined at 285 that no conflicts are detected, the process 280 loops back to continue monitoring CM parameter changes at 281. To the extent it is determined at 285 that conflicts are identified, the process 280 proceeds to step 282. In step 282, a composite CM parameter setting is determined based on the observed CM parameter changes. This composite setting aims to resolve conflicts and optimize the overall network configuration by aggregating individual parameter changes into a unified setting.

At step 283, the composite CM parameter setting is applied across the group of RIC applications. This application ensures that all applications operate under a consistent configuration, reducing the likelihood of conflicts and enhancing network efficiency. The process then returns to step 281 to continue monitoring CM parameter changes, maintaining an ongoing cycle of optimization and conflict resolution within the ORAN system.

While for purposes of simplicity of explanation, the respective processes are shown and described as a series of blocks in FIGS. 2J and 2K, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

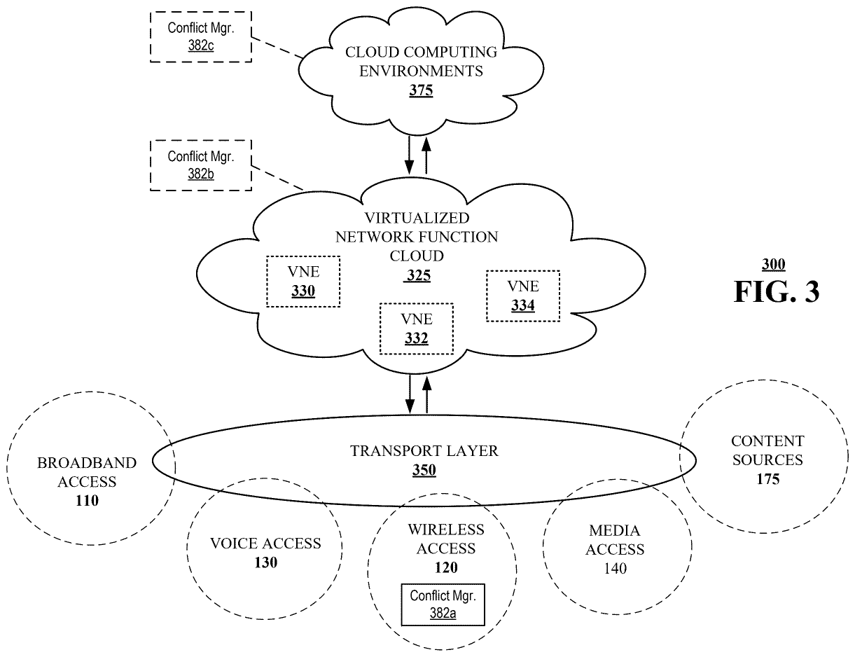

Referring now to FIG. 3, a block diagram is shown illustrating an example, non-limiting embodiment of a virtualized network system 300 in accordance with various aspects described herein. In particular a virtualized communication network is presented that can be used to implement some or all of the subsystems and functions of the network system 100, the subsystems and functions of systems 200, 210, 225, 250, 260, 300 and processes 270 and 280 presented in FIGS. 1, 2A, 2B, 2D, 2F, 2H, 2J, 2K and 3. For example, the virtualized network system 300 can facilitate in whole or in part monitoring configuration management parameter changes over a group of application programs, e.g., xApps and/or rApps, in a RIC and mitigating configuration conflicts in ORAN systems by determining composite configuration management parameters that can be dynamically managed changed across the application programs to enhance network performance and reduce signaling load.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs), reduces complexity from services and operations, supports more nimble business models, and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc., that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. At other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc., to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc., can be instantiated and managed using an orchestration approach similar to those used in cloud compute services.

The cloud computing environments 375 can interface with the virtualized network function cloud 325 via APIs that expose functional capabilities of the VNEs 330, 332, 334, etc., to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

In at least some embodiments, the virtualized network system 300 includes an ORAN architecture, e.g., supporting operations of the wireless access network. For example, equipment supporting the wireless access 120 can include a conflict manager 382a configured to monitor configuration management parameter changes over a group of application programs, e.g., xApps and/or rApps, to mitigate configuration conflicts related to the ORAN architecture and to enhance operations of the wireless access 120, e.g., in terms of efficiency, including optimization. In at least some embodiments the configuration manager 382a, in whole or in part, may be located proximate to and/or incorporated within equipment of the wireless access 120, e.g., within a RIC. Alternatively, or in addition, the configuration manager 382b, 382c, in while or in part, may be located remotely from the wireless access 120, e.g., being in communication via the virtualized network function cloud 325 and/or incorporated into the cloud computing environments 375. It is further envisioned that the configuration manager 382a, 382b, 382c, generally 382, may be implemented in whole or in part as a virtual device.

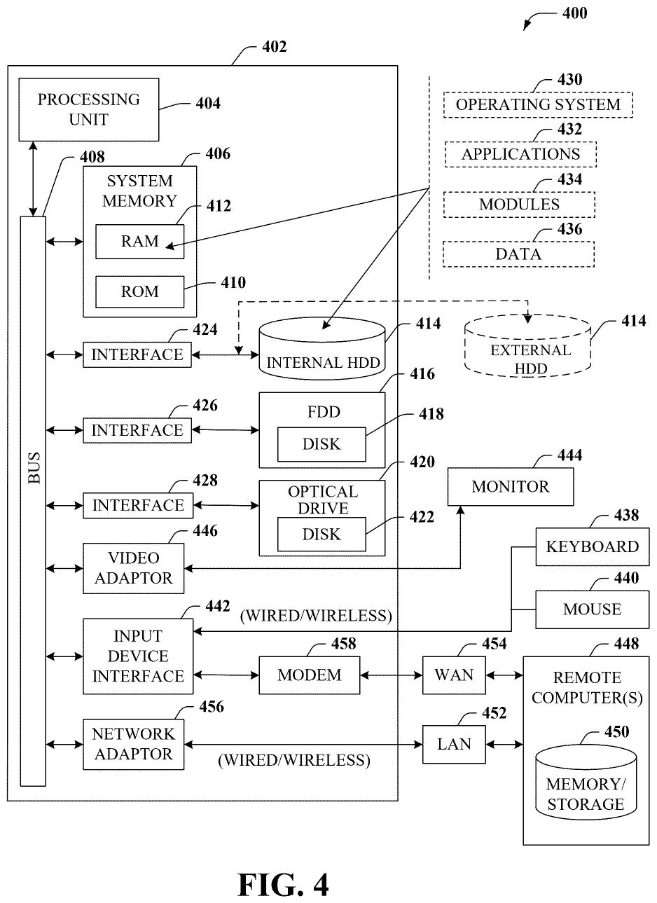

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part monitoring configuration management parameter changes over a group of application programs, e.g., xApps and/or rApps, in a RIC and mitigating configuration conflicts in ORAN systems by determining composite configuration management parameters that can be dynamically managed changed across the application programs to enhance network performance and reduce signaling load.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

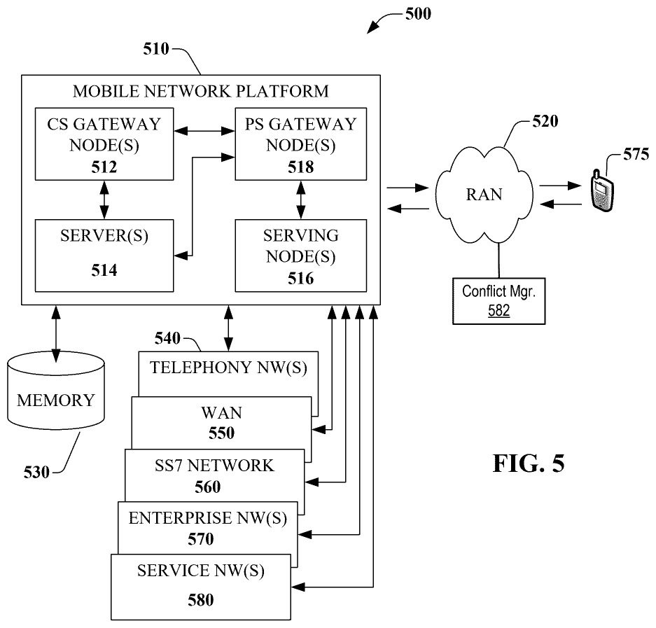

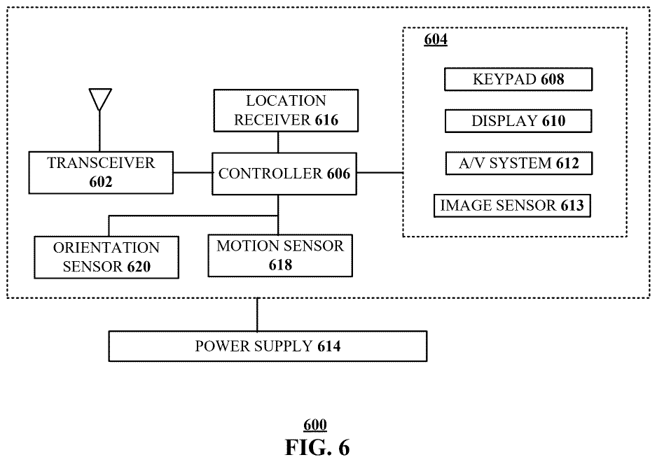

Turning now to FIG. 5, an embodiment of a mobile communication system 500 including a mobile network platform 510 providing an example of network elements 150, 152, 154, 156, and/or VNEs 330, 332, 334, etc. For example, platform 510 can facilitate in whole or in part monitoring configuration management parameter changes over a group of application programs, e.g., xApps and/or rApps, in a RIC and mitigating configuration conflicts in ORAN systems by determining composite configuration management parameters that can be dynamically managed changed across the application programs to enhance network performance and reduce signaling load. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In the example embodiment, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc., that perform particular tasks and/or implement particular abstract data types.

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part monitoring configuration management parameter changes over a group of application programs, e.g., xApps and/or rApps, in a RIC and mitigating configuration conflicts in ORAN systems by determining composite configuration management parameters that can be dynamically managed changed across the application programs to enhance network performance and reduce signaling load.

In at least some embodiments, the mobile communication system 500 includes an ORAN architecture, e.g., supporting operations of the wireless access network. For example, equipment scan include a conflict manager 582 configured to monitor configuration management parameter changes over a group of application programs, e.g., xApps and/or rApps, to mitigate configuration conflicts related to the ORAN architecture and to enhance operations of the mobile network, and in particular the RAN 520, e.g., in terms of efficiency, including optimization.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, 5G as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, X=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
monitoring, by a processing system including a processor, configuration management parameter changes executed by a plurality of application programs operating within a radio access network (RAN) intelligent controller (RIC) framework of a mobile communication system, wherein the configuration management parameter changes adapt the mobile communication system according to mobile service requirements;
determining, by the processing system, a composite configuration management parameter setting based on performance measurements feedback;
applying, by the processing system, the composite configuration management parameter setting across the plurality of application programs;
monitoring, by the processing system, network condition changes of the mobile communication system; and
dynamically adjusting, by the processing system, the composite configuration management parameter setting responsive to the network condition changes to maintain network performance.

2. The method of claim 1, wherein the composite configuration management parameter setting comprises a weighted aggregate of individual configuration management parameter changes.

3. The method of claim 1, wherein the application programs comprise one of a near-real-time, xApp application program, a non-real-time, rApp application program, or a combination thereof.

4. The method of claim 1, further comprising:
determining network conditions, wherein the composite configuration management parameter setting is based on network conditions.

5. The method of claim 1, wherein the determining the composite configuration management parameter setting further comprises:
optimizing, by the processing system, one or more composite configuration management parameters of the composite configuration management parameter setting to obtain an optimized composite configuration management parameter setting.

6. The method of claim 1, further comprising:
identifying, by the processing system, conflicts occurring within the configuration management parameter changes, wherein the composite configuration management parameter setting is configured to reduce the conflicts.

7. The method of claim 1, wherein the composite configuration management parameter setting is configured to reduce a control signaling load within the RAN.

8. The method of claim 1, further comprising:
coordinating, by the processing system, execution of the application programs to ensure synchronized modifications of configuration management parameters, thereby mitigating oscillating of the configuration management parameter changes.

9. The method of claim 1, further comprising:
identifying, by the processing system, a group of neighboring cells;
monitoring, by the processing system, performance measurement feedback for the group of neighboring cells, wherein the performance measurement feedback is responsive to the configuration management parameter changes;
detecting, by the processing system, a performance degradation based on the performance measurement feedback; and
determining, by the processing system, an association between the performance degradation and the configuration management parameter changes.

10. The method of claim 9, further comprising:
obtaining, by the processing system, performance measurement feedback; and
determining, by the processing system, the composite configuration management parameter setting based on performance measurements feedback.

11. The method of claim 10, wherein the network condition changes comprise one of busy hours, emergencies and combinations thereof.

12. A device, comprising:
a processing system including a processor; and
a memory that stores executable instructions that, when executed by the processing system, facilitate performance of operations, the operations comprising:
observing configuration management parameter changes executed by a plurality of application programs operating within a radio access network (RAN) intelligent controller (RIC), wherein the configuration management parameter changes adapt a mobile communication system according to mobile service requirements;
determining a compromise configuration management parameter setting based on performance measurements feedback;
applying the compromise configuration management parameter setting across the plurality of application programs;
monitoring network condition changes of the mobile communication system; and
dynamically adjusting the compromise configuration management parameter setting responsive to the network condition changes to maintain network performance.

13. The device of claim 12, wherein the application programs comprise one of a near-real-time, xApp application program, a non-real-time, rApp application program, or a combination thereof.

14. The device of claim 12, wherein the compromise configuration management parameter setting comprises a weighted aggregate of individual configuration management parameter changes.

15. The device of claim 12, wherein the operations further comprise:
coordinating execution of the application programs to ensure synchronized modifications of configuration management parameters, thereby mitigating oscillating of the configuration management parameter changes.

16. The device of claim 12, wherein the operations further comprise:
identifying a group of neighboring cells;
monitoring performance measurement feedback for the group of neighboring cells, wherein the performance measurement feedback is responsive to the configuration management parameter changes;
detecting a performance degradation based on the performance measurement feedback; and
determining an association between the performance degradation and the configuration management parameter changes.

17. The device of claim 16, wherein the operations further comprise:
obtaining performance measurement feedback; and
determining the compromise configuration management parameter setting based on performance measurements feedback.

18. The device of claim 17, wherein the group of neighboring cells comprise at least one of an eNB, a 5G gNB, or a 6GgNB.

19. A non-transitory machine-readable medium, comprising executable instructions that, when executed by a processing system including a processor, facilitate performance of operations, the operations comprising:
monitoring configuration management parameter changes executed by a plurality of application programs operating within a radio access network (RAN) intelligent controller (RIC), wherein the configuration management parameter changes adapt a communication system according to key performance indicators of a communication system;
determining a compromise configuration management parameter setting based on measurement of the key performance indicators;
applying the compromise configuration management parameter setting across the plurality of application programs;
detecting network condition changes of the communication system; and
dynamically adjusting the compromise configuration management parameter setting responsive to the network condition changes to satisfy the key performance indicators.

20. The non-transitory machine-readable medium of claim 19, wherein the operations further comprise:
coordinating execution of the application programs to ensure synchronized modifications of configuration management parameters, thereby mitigating oscillation of the configuration management parameter changes.
